(19) United States
(12) Patent Application Publication
(10) Pub. No.: US 2006/0121300 A1
(43) Pub. Date: Jun. 8, 2006

(54) Wood modified with silicone emulsion composition

(75) Inventor: Kazuyuki Matsumura, Gunma-ken (JP)

Correspondence Address: BIRCH STEWART KOLASCH & BIRCH, PO BOX 747, FALLS CHURCH, VA, 22040-0747, US

(73) Assignee: Shin-Etsu Chemical Co., Ltd.

(21) Appl. No.: 11/289,420

(22) Filed: Nov. 30, 2005

(30) Foreign Application Priority Data
Dec. 6, 2004 (JP) 2004-352717

(51) Int. Cl. B27K 3/15

(52) U.S. Cl. 428/541

(57) ABSTRACT

Wood is coated or impregnated with a silicone emulsion composition comprising (A) an organopolysiloxane having at least two silicon-bonded hydroxyl groups, (B) the reaction product of an amino-containing organoalkoxysilane and an acid anhydride, and optionally, (C) an epoxy-containing organoalkoxysilane and/or a partial hydrolyzate thereof, (D) colloidal silica and/or polysilsesquioxane, and (E) a curing catalyst, components (A) to (E) being emulsified and dispersed in water in the presence of a surfactant. The modified wood prevents water absorption, has dimensional stability and when previously impregnated with chemicals, is effective for preventing the chemicals from being leached out.

### CROSS-REFERENCE TO RELATED APPLICATION

This non-provisional application claims priority under 35 U.S.C. §119(a) on Patent Application No. 2004-352717 filed in Japan on Dec. 6, 2004, the entire contents of which are hereby incorporated by reference.

### TECHNICAL FIELD

This invention relates to modified wood in which wood is coated or impregnated with a silicone emulsion composition which crosslinks to forms a rubbery coating, so as to achieve improvements in water absorption prevention, dimensional stability, and the leachability in water of chemicals (e.g., flame retardants, antibacterial agents, mildew-proofing agents, termite-controlling agents) with which wood has been impregnated, without detracting from wooden quality.

### BACKGROUND ART

While wood is widely utilized as building materials, crafted products and the like, it is a common practice that wood is coated or impregnated with various treating agents such as high-molecular weight compounds, low-molecular weight compounds, chemical agents and inorganic materials for the purpose of improving wood properties such as dimensional stability, and resistances to water, staining, fire, rotting, crazing and wear.

Among these agents, many attempts have been made to apply to wood the silicones which have been proven effective as modifiers for paints and resins with respect to water repellence and resistance to staining. For example, JP-A 56-4408 discloses a method of coating a surface of wood with a composition comprising 100 pbw of a silicone diol having a relatively high viscosity and 0.1 to 50 pbw of a crosslinker, followed by curing. This method, however, detracts from the wooden quality on the wood surface, and has the drawback common to paints that the effect of protecting the wood interior disappears if the surface coating receives only a few flaws in the course of actual use of wood in various applications. When the above treatment is performed on the wood which has been internally impregnated with inorganic salts of phosphoric or boric acid serving as flame retardants or termite-controlling agents, undesirably the coating permits the inorganic salts to be readily leached out in rain water or the like.

Intending to apply the sol-gel method using silicon alkoxide to wood, JP-A 63-265601 discloses a method of preparing a modified wood by forming a silicone polymer within cell walls of wood. This method capable of forming a silicone polymer within wood has advantages that the wooden quality on the surface is not compromised and the effect lasts even after the wood surface flaws. However, catalysts such as hydrochloric acid or organometallic compounds must be used to promote curing because of the low reactivity of monomers, leaving the problems that preparation requires cumbersome operation and costs and the wood itself can be degraded by the catalyst.

Additionally, the silicone polymer forms via catalytic reaction while filling wood cell cavities therewith. Then it is effective for prohibiting water absorption to some extent, but less effective for improving dimensional stability.

Beside the silicone, SBR latex is coated to wood surface as the anti-crazing agent as disclosed in JP-A 54-110234. Due to poor stability over time, the latex coating degrades upon outdoor exposure, failing to prevent the chemical agents from being leached out.

As the anti-crazing paint for wood, JP-A 60-255866 describes a coating composition comprising an SBR or NBR latex and a polyalkylene oxide group-containing compound, which is coated to wood surface. The polyalkylene oxide group-containing compound is hydrophilic so that it is leached out upon exposure to weather over time, and the effect does not last.

JP-A 55-118044 discloses a wood treating composition having a low-volatile oligomer emulsified in water. JP-A 5-69412 discloses a wood treating composition comprising a water-soluble modifier and an emulsion. Both the low-volatile oligomer and the water-soluble modifier are hydrophilic compounds which can be leached out with the lapse of time, failing to maintain the desired effect. JP-A 4-307204 discloses a wood processing composition comprising a water-soluble filling/curing agent which cures after having penetrated into wood so that it prevents chemical agents from being leached out and restrains the wood from shrinkage. The water-soluble filling/curing agent comprising volatile reagents such as urea and formalin requires careful management of the working environment, and the effect of preventing leaching-out is insufficient due to water solubility.

Another approach is to substitute a water-soluble solvent such as polyethylene glycol for the bound water in cell membranes. However, the solvent once substituted will be leached out over time due to its water solubility.

### SUMMARY OF THE INVENTION

An object of the present invention is to provide a modified wood featuring water absorption prevention, dimensional stability, and minimized leach-out of impregnated chemical agents.

The inventors have found that when wood is coated or impregnated with a silicone emulsion composition comprising the following components (A) to (E) emulsified and dispersed in water in the presence of a surfactant, which composition crosslinks to form a rubbery coating, a modified wood featuring water absorption prevention, dimensional stability, and minimized leach-out of impregnated chemical agents is obtained in a simple manner at low costs.

The invention provides a modified wood in which wood is coated, impregnated or otherwise treated with a silicone emulsion composition comprising the following components (A) to (E) emulsified and dispersed in water in the presence of a surfactant,

(A) 100 parts by weight of an organopolysiloxane having at least two silicon-bonded hydroxyl groups on the molecule,

(B) 0.5 to 20 parts by weight of the reaction product of an amino-containing organoalkoxysilane and an acid anhydride,

(C) 0 to 20 parts by weight of an epoxy-containing organoalkoxysilane and/or a partial hydrolyzate thereof,

(D) 0 to 50 parts by weight of colloidal silica and/or polysilsesquioxane, and

(E) 0 to 10 parts by weight of a curing catalyst.

In a preferred embodiment, the wood has been internally or surface treated with at least one member selected from among a flame retardant, antibacterial agent, mildew-proofing agent, termite-controlling agent, water repellent and paint, prior to the treatment with the silicone emulsion composition. The flame retardant, antibacterial agent, mildew-proofing agent or termite-controlling agent is typically a boron compound or phosphorus compound.

When wood is treated with the silicone emulsion composition according to the invention, the modified wood has resistance to water absorption and dimensional stability and is effective for preventing the chemical agents, with which the wood has been impregnated, from being leached out.

As used herein, the notation (Cₙ-Cₘ) means a group containing from n to m carbon atoms per group. All parts are by weight unless otherwise stated.

### DESCRIPTION OF THE PREFERRED EMBODIMENTS

The modified wood of the invention is obtained by coating or impregnating wood with a silicone emulsion composition comprising the following components (A) to (E) which are emulsified and dispersed in water in the presence of a surfactant. The respective components are described in detail.

Component (A) is an organopolysiloxane having at least two silicon-bonded hydroxyl groups on the molecule. The preferred organopolysiloxane has the general formula (1). 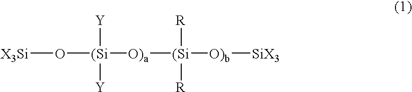
Herein R which may be the same or different is a C₁-C₂₀ alkyl group or C₆-C₂₀ aryl group; X which may be the same or different is a C₁-C₂₀ alkyl group, C₆-C₂₀ aryl group, C₁-C₂₀ alkoxy group or hydroxyl group; Y which may be the same or different is X or a group —[O—Si(X)₂]_{c}—X, the subscript a is a number of 0 to 1,000, b is a positive number of 100 to 10,000, and c is a positive number of 1 to 1,000. This organopolysiloxane should have at least two silicon-bonded hydroxyl groups on the molecule.

More particularly, in formula (1), R is each independently selected from C₁-C₂₀ alkyl groups and C₆-C₂₀ aryl groups, such as methyl, ethyl, propyl, butyl, pentyl, hexyl, heptyl, octyl, nonyl, decyl, dodecyl, tetradecyl, hexadecyl, octadecyl, cyclopentyl, cyclohexyl, cycloheptyl, phenyl, tolyl, and naphthyl, with methyl being preferred. X is each independently selected from C₁-C₂₀ alkyl groups, C₆-C₂₀ aryl groups, C₁-C₂₀ alkoxy groups and hydroxyl groups, such as methyl, ethyl, propyl, butyl, pentyl, hexyl, heptyl, octyl, nonyl, decyl, dodecyl, tetradecyl, hexadecyl, octadecyl, cyclopentyl, cyclohexyl, cycloheptyl, phenyl, tolyl, naphthyl, methoxy, ethoxy, propoxy, butoxy, hexyloxy, heptyloxy, octyloxy, decyloxy, and tetradecyloxy as well as hydroxyl. It is preferred that one of the three X's at each end be hydroxyl. Y is each independently selected from X and groups —[O—Si(X)₂]_{c}—X wherein c is a positive number of 1 to 1,000. If “a” is more than 1,000, the resulting coating has insufficient strength. Thus “a” is a number of 0 to 1,000, preferably 0 to 200. If b is less than 100, the resulting coating becomes less flexible. If b is more than 10,000, the resulting coating has reduced tear strength. Thus b is a positive number of 100 to 10,000, preferably 1,000 to 5,000. For crosslinking, at least two silicon-bonded hydroxyl groups must be included on the molecule.

Illustrative examples of the organopolysiloxane are given below. 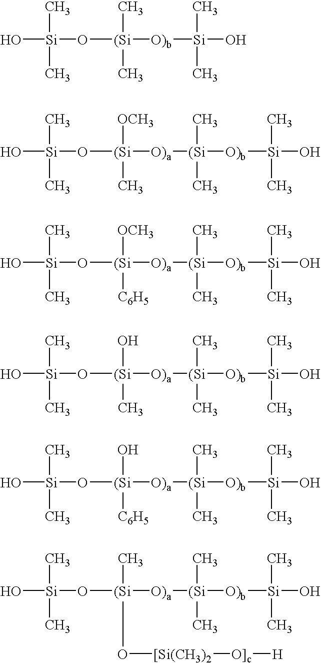
Herein, a, b and c are as defined above.

Such organopolysiloxane can be synthesized by well-known methods. For example, it is obtained through equilibration reaction between a cyclic siloxane such as octamethylcyclotetrasiloxane and an α,ω-dihydroxysiloxane oligomer in the presence of a catalyst such as a metal hydroxide. Since component (A) is preferably used in emulsion form, it may be prepared as an emulsion by a well-known emulsion polymerization method. Thus it may be readily synthesized by previously emulsifying and dispersing a cyclic siloxane or an α,ω-dihydroxysiloxane oligomer, an α,ω-dialkoxysiloxane oligomer, alkoxysilane or the like in water using an anionic or cationic surfactant, optionally adding a catalyst such as an acid or basic material, and effecting polymerization reaction.

Component (B) is the reaction product of an amino-containing organoalkoxysilane and an acid anhydride, which serves to improve the adhesion of a silicone coating to the substrate or wood. The product is obtained by reacting an amino-containing organoalkoxysilane with a dicarboxylic acid anhydride. The amino-containing organoalkoxysilane as one reactant has the general formula (2). 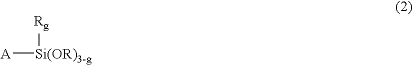
Herein R is as defined above, A is an amino-containing group of the formula —R¹(NHR¹)ₕNHR² wherein R¹ is each independently a divalent hydrocarbon group such as C₁-C₆ alkylene, R² is R or hydrogen, h is an integer of 0 to 6, and g is 0, 1 or 2. Illustrative examples of the amino-containing organoalkoxysilane are given below.
(C₂H₅O)₃SiC₃H₆NH₂
(C₂H₅O)₂(CH₃)SiC₃H₆NH₂
(CH₃O)₃SiC₃H₆NH₂
(CH₃O)₂(CH₃)SiC₃H₆NH₂
(CH₃O) ₃SiC₃H₆NHC₂H₄NH₂
(CH₃O)₂ (CH₃)SiC₃H₆NHC₂H₄NH₂

Examples of the dicarboxylic anhydride for reaction with the amino-containing organoalkoxysilane include maleic anhydride, phthalic anhydride, succinic anhydride, methylsuccinic anhydride, glutaric anhydride, and itaconic anhydride, with maleic anhydride being preferred. The reaction is performed simply by mixing the reactants in such amounts that a molar ratio of amino groups to acid anhydride is 0.5-2:1, optionally in a hydrophilic organic solvent, at room temperature or elevated temperature. Suitable hydrophilic organic solvents, if used, include alcohols such as methanol, ethanol, isopropanol and butanol, ketones such as acetone and methyl ethyl ketone, acetonitrile, and tetrahydrofuran.

An appropriate amount of component (B) is 0.5 to 20 parts by weight per 100 parts by weight of component (A). Less than 0.5 part of component (B) fails to improve the adhesion to wood whereas more than 20 parts of component (B) makes the coating hard and brittle. The preferred amount of component (B) is 1 to 10 parts by weight.

Component (C) is an epoxy-containing organoalkoxysilane and/or a partial hydrolyzate thereof, which serves to improve the adhesion of a silicone coating to the substrate or wood. Examples include γ-glycidoxypropyltrimethoxysilane, γ-glycidoxypropyldimethoxymethylsilane, β-(3,4-epoxycyclohexyl)ethyltrimethoxysilane, and β-(3,4-epoxycyclohexyl)ethyldimethoxymethylsilane. Partial hydrolyzates of these silanes are also included.

An appropriate amount of component (C) is 0 to 20 parts by weight per 100 parts by weight of component (A). More than 20 parts of component (C) makes the coating hard and brittle. The preferred amount of component (C) is 0 to 10 parts by weight. When used, the amount of component (C) is preferably at least 0.5 part, more preferably at least 1 part by weight.

Component (D) is colloidal silica and/or polysilsesquioxane, which serves as a coating reinforcement. Examples include colloidal silica and polymethylsilsesquioxane which is a hydrolytic condensate of trimethoxymethylsilane.

Some colloidal silicas which can be used herein are commercially available. While the type is not critical, those colloidal silicas stabilized with sodium, ammonium or aluminum and having a particle size of 5 to 50 nm are preferable. Suitable commercial examples include Snowtex by Nissan Chemical Industries, Ltd., Ludox by Dupont, Silicadol by Nippon Chemical Industrial Co., Ltd., Adelite AT by Asahi Denka Co., Ltd., and Cataloid S by Catalysts & Chemicals Industries Co., Ltd.

Polymethylsilsesquioxane is obtained by adding an acid such as sulfuric acid or a basic compound such as potassium hydroxide as a condensation catalyst to an aqueous solution of a surfactant, adding dropwise trimethoxymethylsilane thereto, and stirring the mixture, thereby yielding an emulsion of polymethylsilsesquioxane. In this reaction, it is acceptable to add an alkoxytrialkylsilane, dialkoxydialkylsilane, tetraalkoxysilane or the like for adjusting the degree of crosslinking of polysilsesquioxane. It is also acceptable to add a vinylsilane, epoxysilane, acrylic silane, methacrylic silane or the like for enhancing the reactivity of polysilsesquioxane.

An appropriate amount of component (D) is 0 to 50 parts by weight per 100 parts by weight of component (A). More than 50 parts of component (D) makes the silicone coating hard and brittle. The preferred amount of component (D) is 0 to 30 parts by weight. When used, the amount of component (D) is preferably at least 1 part by weight, more preferably at least 3 parts by weight. Also preferably component (D) has an average particle size of 2 to 200 nm.

Component (E) is a curing catalyst for inducing condensation reaction of the components of the composition for achieving quick crosslinking and curing. Suitable catalysts include metal salts of organic acids such as dibutyltin dilaurate, dibutyltin dioctate, dioctyltin dilaurate, dioctyltin diversatate, dioctyltin diacetate, dibutyltin bisoleylmaleate, tin octylate, zinc stearate, zinc octylate, zinc acetate and iron octylate; and amine compounds such as n-hexylamine and guanidine. These curing catalysts except water-soluble ones are desirably emulsified and dispersed in water with the aid of surfactants to form emulsions, prior to use.

An appropriate amount of component (E) is 0 to 10 parts by weight per 100 parts by weight of component (A). If more than 10 parts of the catalyst is used, a portion thereof can be left in the coating as non-volatile matter and adversely affect the coating properties. The preferred amount of component (E) is 0 to 5 parts by weight. When used, the amount of component (E) is preferably at least 0.5 part by weight, more preferably at least 1 part by weight.

In the emulsion composition thus formulated, silane coupling agents, silicone resins, silicone oils, or powdered silicone resins may be added and compounded, if desired, for further improving the properties of a coating thereof, as long as the objects of the invention are not compromised. Suitable silane coupling agents include various silanes having acryloxy, methacryloxy, mercapto, carboxyl and cyano groups. Suitable silicone resins are trialkylsiloxypolysilicates. Suitable silicone oils include α,ω-dihydroxyalkylpolysiloxanes and alkylpolysiloxanes. Suitable powdered silicone resins include silicone resin powder and silicone rubber powder.

Similarly, various other additives may be compounded if desired, such as, for example, thickeners, pigments, dyes, penetrants, antistatic agents, antifoaming agents, preservatives, flame retardants, antibacterial agents, termite-controlling agents, and water repellents.

The wood which can be treated with the silicone emulsion composition of the invention is not particularly limited and encompasses a variety of woods including solid wood, plywood, laminated veneer lumbers (LVL), particle boards, and processed woods such as incombustible wood and termite-controlled wood in which wood is impregnated or coated with one or more of preservatives, flame retardants, antibacterial agents, termite-controlling agents and water repellents. The invention is applicable particularly to wood members impregnated with boron compounds or phosphorus compounds.

Suitable boron compounds include boric acid, borax, borates such as Tim-bor® (Na₂B₈O₁₃.4H₂O) available from U.S. Borax Inc., and trialkyl borates such as trimethyl borate, triethyl borate, tripropyl borate and tributyl borate. Suitable phosphorus compounds include phosphates such as triammonium phosphate, diammonium hydrogen phosphate, monoammonium dihydrogen phosphate, ammonium polyphosphate, sodium phosphate, disodium hydrogen phosphate, sodium dihydrogen phosphate, and sodium polyphosphate; phosphorous acid, and trialkyl phosphates such as trimethyl phosphite, triethyl phosphate, tripropyl phosphate, and tributyl phosphite; phosphoric acid and trialkyl phosphates such as trimethyl phosphate, triethyl phosphate, tripropyl phosphate, and tributyl phosphate.

A coating of the silicone emulsion composition of the invention is effective for preventing water absorption and has a good ability to follow the substrate due to rubbery quality, suggesting that it is unsusceptible to cracking. When wood which has been impregnated with a flame retardant and/or termite-controlling agent is coated with the silicone emulsion composition, the resultant coating can impart the effect of preventing the chemicals from being leached out in water, typically rain water.

The method of applying the silicone emulsion composition of the invention is not critical, and any of well-known methods such as roll coating, spray coating and dip coating may be employed. Once the silicone emulsion composition is applied, it is dried at normal temperature, forming a cured coating. The processing time can be reduced by heating for promoting the cure. The cured coating has rubbery quality.

The amount of the silicone emulsion composition with which wood is treated according to the invention may be determined as appropriate although the amount of the emulsion coated is preferably 1 to 100 kg of solids per cubic meters of wood, more preferably 10 to 30 kg/m³. For ease of application and the like, the silicone emulsion composition should preferably have a viscosity of 1 to 1,000 Pa·s, more preferably 1 to 100 Pa·s, as measured by a rotational viscometer at 25° C. It is understood that the viscosity can be adjusted, if desired, by adding a thickener.

### EXAMPLE

Preparation Examples, Examples and Comparative Examples are given below for further illustrating the present invention. These examples should not be construed as limiting the invention. Unless otherwise stated, % is by weight.

### Preparation Example 1

A 2-L polyethylene beaker was charged with 498 g of octamethylcyclotetrasiloxane, 2 g of triethoxyphenylsilane, 50 g of 10% sodium laurylsulfate aqueous solution and 50 g of 10% dodecylbenzenesulfonate aqueous solution, which were homogeneously emulsified using a homomixer. Water, 400 g, was slowly added for dilution, and the diluted liquid passed twice through a high-pressure homogenizer under a pressure of 300 kg/cm², yielding a homogeneous white emulsion. This emulsion was transferred to a 2-L glass flask equipped with a stirrer, thermometer and reflux condenser, where it was subjected to polymerization reaction at 50° C. for 24 hours, and aging at 10° C. for 24 hours. This was followed by neutralization to pH 6.2 with 12 g of 10% sodium carbonate aqueous solution. The emulsion thus obtained had a nonvolatile content of 45.4% upon drying at 105° C. for 3 hours, and contained a non-flowing, soft gel-like organopolysiloxane having an average composition represented by [(CH₃)₂SiO_{2/2}]/[(C₆H₅)SiO_{3/2}]=100/0.1 (molar ratio) and end-capped with hydroxyl groups. In this way, an emulsion [A-1] containing 44.4% component (A) was obtained.

### Preparation Example 2

A 2-L polyethylene beaker was charged with 500 g of octamethylcyclotetrasiloxane, 50 g of 10% sodium laurylsulfate aqueous solution and 50 g of 10% dodecylbenzenesulfonate aqueous solution, which were homogeneously emulsified using a homomixer. Water, 400 g, was slowly added for dilution, and the diluted liquid passed twice through a high-pressure homogenizer under a pressure of 300 kg/cm², yielding a homogeneous white emulsion. This emulsion was transferred to a 2-L glass flask equipped with a stirrer, thermometer and reflux condenser, where it was subjected to polymerization reaction at 50° C. for 24 hours, and aging at 10° C. for 24 hours. This was followed by neutralization to pH 6.2 with 12 g of 10% sodium carbonate aqueous solution. The emulsion thus obtained had a nonvolatile content of 45.5% upon drying at 105° C. for 3 hours, and contained a gum-like organopolysiloxane of the formula HO—[(CH₃)₂SiO]ₙ—H having a viscosity of at least 1,000 Pa·s at 25° C. In this way, an emulsion [A-2] containing 44.5% component (A) was obtained.

### Preparation Example 3

Maleic anhydride, 154 g, was dissolved in 500 g-of ethanol, after which 346 g of 3-aminopropyltriethoxysilane was added dropwise at room temperature over one hour. Reaction was performed under ethanol reflux at 80° C. for 24 hours, yielding a pale yellow clear solution [B-1] containing 50% of component (B). This solution had a nonvolatile content of 45.1% upon drying at 105° C. for 3 hours. The reaction product in the solution consisted of about 60% of a mixture of (C₂H₅O)₃SiC₃H₆—NHCO—CH═CHCOOH and (C₂H₅O)₃SiC₃H₆NH₃⁺⁻OCOCH═CHCOOC₂H₅ and the remainder (about 40%) of oligomers derived therefrom, as analyzed by IR, GC, NMR and GCMS.

### Preparation Example 4

A 2-L polyethylene beaker was charged with 300 g of dioctyltin dilaurate and 50 g of polyoxyethylene nonyl phenyl ether (EO 10 mole addition product), which were homogeneously mixed using a homomixer. Water, 650 g, was slowly added for achieving emulsion dispersion in water, and the dispersion passed twice through a high-pressure homogenizer under a pressure of 300 kg/cm², yielding an emulsion [E-1] containing 30% of component (E).

A series of silicone emulsion compositions #1 to #7 were prepared by blending components (A) to (E) in accordance with the formulation shown in Table 1. Note that γ-glycidoxypropyltrimethoxysilane [C-1] and colloidal silica (Snowtex C by Nissan Chemical Industries, Ltd., active ingredient 20%) [D-1] were used as components (C) and (D), respectively. With stirring, 4 g of carboxymethyl cellulose (Cellogen F-SA by Dai-Ichi Kogyo Seiyaku Co., Ltd.) was added to 500 g of the silicone emulsion compositions for adjusting to a viscosity of 15 Pa·s at 25° C.

TABLE 1
Mixing formulation

| | | Silicone emulsion composition | | | | | | |
|---|---|---|---|---|---|---|---|---|
| (unit: pbw) | | #1 | #2 | #3 | #4 | #5 | #6 | #7 |
| | A-1 | 100 | — | 100 | 100 | — | 100 | — |
| Component A | A-2 | — | 100 | — | — | 100 | — | 100 |
| Component B | B-1 | 5 | 8 | 10 | 20 | 0.5 | 0.5 | 5 |
| Component C | C-1 | 5 | 8 | — | — | 20 | 2 | 5 |
| Component D | D-1 | 15 | — | 10 | — | — | 50 | 15 |
| Component E | E-1 | 1 | 0.5 | 1 | 1 | 1 | — | 0.1 |

### Example 1

Silicone emulsion composition #1 was diluted with water to an active ingredient content of 20%, which was a treating liquid. Three cedar sap wood pieces (air dried) of 1.4 cm×3 cm×3 cm (butt end 1.4×3 cm) were dipped in the treating liquid at normal temperature and atmospheric pressure for 10 minutes and dried at 25° C. for 7 days, obtaining modified wood pieces. A water absorption test was carried out on these samples as follows. The results are shown in Table 2.

Water Absorption Test

The samples were entirely immersed in water for 24 hours, after which they were taken out and weighed. A percent water absorption was calculated according to the equation:
% water absorption=[(W−W0)/W0]×100
wherein W0 is the weight of the sample before water immersion and W is the weight of the sample immediately after water immersion. An average of three samples was reported.

### Examples 2 to 7

Using silicone emulsion compositions #2 to #7, a water absorption test was carried out as in Example 1. The results are shown in Table 2.

### Comparative Example1

Using untreated cedar sap wood pieces of the same size as in Example 1, a water absorption test was carried out as in Example 1. The results are shown in Table 2.

### Comparative Example 2

With stirring, 2 g of 0.1N hydrochloric acid and 35 g of water were added to a liquid mixture of 75 g of methyltrimethoxysilane, 20 g of tetraethoxysilane, 5 g of dimethyldimethoxysilane, 100 g of isopropanol and 0.05 g of zirconocene dichloride. The mixture was stirred for 3 hours and then allowed to stand for 8 hours. Wood pieces were treated as in Example 1 with the thus obtained liquid, designated silane treating liquid #1. On the resulting samples, a water absorption test was carried out as in Example 1. The results are shown in Table 2.

### Comparative Example 3

To 100 g of α, ω-dihydroxypoly(dimethylsiloxane) having a viscosity of 50,000 mPa·s at room temperature was added an equal volume of xylene. The siloxane was thoroughly dissolved. Then 4 g of a partial hydrolytic condensate of methyltriacetoxysilane and 0.01 g of dibutyltin dilaurate were added to the solution, which was thoroughly mixed under moisture-proof conditions. Wood pieces were treated as in Example 1 with the thus obtained liquid, designated silane treating liquid #2. On the resulting samples, a water absorption test was carried out as in Example 1. The results are shown in Table 2.

### Comparative Example 4

A reactor equipped with a stirring impeller, thermometer, reflux condenser and dropping funnel was charged with 2.0 g of a reactive emulsifier (Adeka Reasoap SE-10N, Asahi Denka Co., Ltd.) and 342.1 g of water and heated to a temperature of 75° C. An emulsion was prepared by adding 2.0 g of a reactive emulsifier (Adeka Reasoap SE-10N, Asahi Denka Co., Ltd.) to 244.5 g of water, dissolving the emulsifier, further adding a mixture of unsaturated monomers: 230 g of 2-ethylhexyl acrylate, 230 g of styrene, 19 g of glycidyl methacrylate, and 12.5 g of methacrylic acid, and stirring the contents for emulsification. This emulsion was charged to the dropping funnel. A 5% portion of this monomer mixture emulsion was transferred to the reactor, and 0.5 g of potassium persulfate added as a polymerization initiator, after which the reactor was heated to 80° C. and held for 10 minutes. Thereafter, the remainder of the monomer mixture emulsion and 50.0 g of 3% potassium persulfate were evenly added dropwise to the reactor over 3 hours. After the completion of addition, the mixture was held at 80° C. for one hour for maturing reaction. It was cooled to room temperature and neutralized with 3.5 g of aqueous ammonia. There was obtained Emulsion #1 having a solid concentration of 45%. It was diluted with water to a solid concentration of 20%. Wood pieces were treated as in Example 1 with the thus obtained liquid. On the resulting samples, a water absorption test was carried out as in Example 1. The results are shown in Table 2.

TABLE 2
% water absorption after 24-hour immersion

| | Water absorption (%) |
|---|---|
| Example 1 | 12 |
| Example 2 | 11 |
| Example 3 | 13 |
| Example 4 | 15 |
| Example 5 | 16 |
| Example 6 | 15 |
| Example 7 | 14 |
| Comparative Example 1 | 123 |
| Comparative Example 2 | 99 |
| Comparative Example 3 | 100 |
| Comparative Example 4 | 85 |

### Example 8

Silicone emulsion composition #1 was diluted with water to an active ingredient content of 20%, which was a treating liquid.

Nine cedar sap wood pieces having a butt section of 20 mm×20 mm and a height of 10 mm with opposed sides of straight grain, which had been impregnated with 5 kg/m³ of borate Na₂B₈O₁₃ ·4H₂O, were dipped in the treating liquid at normal temperature and atmospheric pressure for 10 minutes and dried at 25° C. for 7 days, obtaining modified wood pieces.

A leach-out test was carried out on these samples according to JIS K1571. The amount of residual borate was determined by measuring the amount of boron in the samples after the test by the following procedure. The results are shown in Table 3.

Leach-Out Test

A set of nine wood samples was placed in a 500-ml beaker, to which deionized water in a volume which was 10 times the volume of the samples was poured so that the samples were submerged under the water surface. By installing a magnetic stirrer and rotating the stir bar at 400-450 rpm, the water was stirred at a temperature of 25° C. for 8 hours for leaching out the chemical. Immediately thereafter, the samples were taken out and lightly drained of water from the surface. Subsequently, the samples were held in an air circulating dryer at a temperature of 60° C. for 16 hours, allowing the volatiles to volatilize off. The foregoing procedure was repeated ten times.

Measurement of Residual Borate in Sample

The wood sample was placed in a Teflon® beaker, which received 50 ml of 3% aqueous nitric acid and was heated on a hot plate at 200° C. for 2 hours. The beaker was cooled down, after which water was added to a constant volume of 50 ml. This procedure was repeated five times. At the end of every procedure, the amount of boron was measured by an ICP analyzer. The total of these amounts is the amount of residual borate in the wood sample. The result is an average of nine samples.

### Examples 9 to 14

The leach-out test and the residual borate measurement were carried out as in Example 8 using silicone emulsion compositions #2 to #7. The results are shown in Table 3.

### Comparative Examples 5 to 8

The leach-out test and the residual borate measurement were carried out as in Example 8 using borate-impregnated wood pieces which had not been treated or had been treated with silane treating liquids #1 and #2 and Emulsion #1. The results are shown in Table 3.

TABLE 3

| | Amount of residual borate |
|---|---|
| | (kg/m³) |
| Example 8 | 2.5 |
| Example 9 | 2.7 |
| Example 10 | 2.1 |
| Example 11 | 2.2 |
| Example 12 | 2.3 |
| Example 13 | 2.2 |
| Example 14 | 2.2 |
| Comparative Example 5 | 0.01 |
| Comparative Example 6 | 0.5 |
| Comparative Example 7 | 0.01 |
| Comparative Example 8 | 0.03 |

Japanese Patent Application No. 2004-352717 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A modified wood in which wood is coated or impregnated with a silicone emulsion composition comprising the following components (A) to (E) emulsified and dispersed in water in the presence of a surfactant,
(A) 100 parts by weight of an organopolysiloxane having at least two silicon-bonded hydroxyl groups on the molecule,
(B) 0.5 to 20 parts by weight of the reaction product of an amino-containing organoalkoxysilane and an acid anhydride,
(C) 0 to 20 parts by weight of an epoxy-containing organoalkoxysilane and/or a partial hydrolyzate thereof,
(D) 0 to 50 parts by weight of colloidal silica and/or polysilsesquioxane, and
(E) 0 to 10 parts by weight of a curing catalyst.

2. The modified wood of claim 1 wherein the wood has been internally or surface treated with at least one member selected from the group consisting of a flame retardant, antibacterial agent, mildew-proofing agent, termite-controlling agent, water repellent and paint, prior to the treatment with the silicone emulsion composition.

3. The modified wood of claim 2 wherein the flame retardant, antibacterial agent, mildew-proofing agent or termite-controlling agent is at least one=member selected from boron compounds and phosphorus compounds.
